(19) United States
(12) Patent Application Publication
(10) Pub. No.: US 2009/0161528 A1
(43) Pub. Date: Jun. 25, 2009

(54) METHOD FOR EXTENDING RANGING REGION IN AN OFDMA SYSTEM

(75) Inventors: SAMIR S. VAIDYA, HIGHLAND PARK, NJ (US); MICHAEL N. KLOOS, BELVIDERE, IL (US); MARK G. SPIOTTA, WHEATON, IL (US); JUN WANG, EVANSTON, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/962,187

(22) Filed: Dec. 21, 2007

(51) Int. Cl. H04J 11/00

(52) U.S. Cl. 370/203

(57) ABSTRACT

A method for uplink synchronization, in a wireless communication device, with a base station in a wireless communication system based on Orthogonal Frequency Division Multiple Access (OFDMA) is disclosed. The method comprises selecting (440), by the wireless communication device, at least one ranging slot randomly from ranging slots in at least a transition gap. The wireless communication device further transmits (445) at least one ranging code in the selected at least one ranging slot.

### FIELD OF THE INVENTION

The present disclosure relates generally to an Orthogonal Frequency Division Multiple Access (OFDMA) system and more particularly to a method of extending a ranging region in an OFDMA frame.

### BACKGROUND

In an OFDMA system, the coverage area is divided into a plurality of small areas called cells. Each cell has one or more base stations and each base station communicates with a plurality of wireless communication devices present in the cell. The base station and the plurality of wireless communication devices communicate through a radio frequency band called a channel. The channel is divided into a plurality of slots. In an OFDMA system, a slot is the smallest data allocation unit in the channel that can be assigned to a wireless communication device or a base station. Each slot has at least one sub-channel allocated for at least one symbol time duration. A symbol is the smallest allocation unit in the time domain. A sub-channel is the smallest allocation unit in the frequency domain and has a plurality of orthogonal sub-carriers, where the sub-carriers modulate the data to be transmitted by the wireless communication device.

The wireless communication device and base station transmit and receive data in units called frames. Each frame has a plurality of sub-channels and symbol times. Each frame is divided into a downlink sub-frame, an uplink sub-frame, and some transition gaps to separate the downlink sub-frame from the uplink sub-frame. A transmission from the base station to the wireless communication device is known as a downlink transmission and it occurs in a downlink sub-frame. A transmission from the wireless communication device to the base station is known as an uplink transmission and it occurs in an uplink sub-frame. A complete set of one downlink sub-frame, one uplink sub-frame, one Transmit/Receive Transition Gap (TTG), and one Receive/Transmit Transition Gap (RTG) is called a frame.

Prior art FIG. 1 shows a three stage 191, 193, 195 blow-up of an OFDMA frame 100. The first stage 191 of prior art FIG. 1 shows a plurality of OFDMA frames 101, 102, 103, 104, 105. All of the frames 101, 102, 103, 104, 105 are structurally identical. The first frame 101 has a downlink sub-frame 110, an uplink sub-frame 120, a Transmit/Receive Transition Gap (TTG) 128 and a Receive/Transmit Transition Gap (RTG) 129.

In the example of prior art FIG. 1, the downlink sub-frame 110 is further divided into two portions 112 and 115. The rear portion 115 of the downlink sub-frame 110 includes a plurality of slots that contains the data bursts transmitted by the base station. The forward portion 112 of the downlink sub-frame 110 includes a signaling and control portion with a preamble, a Frame Control Header (FCH), a downlink MAP message (DL-MAP), an uplink MAP message (UL-MAP), a Downlink Channel Descriptor (DCD), and an Uplink Channel Descriptor (UCD).

The preamble indicates the start of the downlink sub-frame to the wireless communication devices. The FCH contains the location of a first downlink data burst (the DL-MAP) following the FCH. The DL-MAP is a message that describes the starting time of the downlink data bursts, and includes PHY synchronization information, a DCD count representing a count corresponding to a change in configuration of the DCD, and a base station ID. The UL-MAP is a message that describes the starting time of the uplink bursts, and includes an uplink channel identifier and a UCD count representing a count corresponding to a change in configuration of the UCD. The DCD describes a downlink burst profile (physical layer characteristics of the downlink sub-frame). The UCD describes an uplink burst profile (physical layer characteristics of the uplink sub-frame).

The uplink sub-frame 120 has a ranging region 125 and an uplink data portion 123. The uplink data portion 123 has a plurality of slots that can be used by a wireless communication device to transmit data to a base station. The ranging region 125 is used by the wireless communication devices for ranging. Ranging is defined as the process of adjusting the timing offset, the frequency offset, and the power of the uplink transmission for synchronizing the wireless communication device's uplink transmission with the base station. Ranging also includes the process of allocation of the bandwidth to the wireless communication devices.

Another part of the first frame 101 is the TTG 128, which separates the downlink sub-frame 110 and the uplink sub-frame 120. The width of a TTG 128 is equal to the sum of the time taken by the wireless communication device to switch its transceiver from the receive mode to the transmit mode plus the round trip propagation delay time. The round trip propagation delay time is the time taken by a signal to travel twice the distance between the base station and the wireless communication device. During the TTG 128, the base station switches its transceiver from the transmit mode to the receive mode.

The last part of the first frame 101 is the RTG 129, which separates the uplink sub-frame 120 of the first frame 101 from the downlink sub-frame of the subsequent frame 102. The width of the RTG 129 is equal to the sum of the time taken by the base station to switch its transceiver from the receive mode to the transmit mode. During the RTG 129, the wireless communication device switches its transceiver from the transmit mode to the receive mode.

The second stage 193 of prior art FIG. 1 shows the uplink sub-frame 120 in detail. The uplink data portion 123 is divided into a plurality of slots. These slots are allocated to the wireless communication devices for transmitting data. The remaining region of the uplink sub-frame 120 is the ranging region 125.

The third stage 195 of prior art FIG. 1 shows in detail, the ranging region 125, and two slots 160, 170 of the uplink data portion 123 of the uplink sub-frame 120. Each slot 160, 170 has three symbol times K+1, K+2, and K+3 in this example. These slots 160, 170 are used by the wireless communication device to transmit data to the base station.

In this example, the ranging region 125 has two ranging slots 130, 150. Each ranging slot 130, 150 has three symbol times K+1, K+2, and K+3 and also uses a plurality of sub-channels. The wireless communication device selects a ranging slot randomly and transmits a ranging code in the selected ranging slot. The ranging code is selected by the wireless communication device randomly from a set of ranging codes allocated for a particular type of ranging being performed by the wireless communication device.

In an OFDMA system, there are four defined types of possible ranging: initial ranging 182, handoff request ranging 184, periodic ranging 186, and bandwidth request ranging 188. The third stage 195 shows all four types of ranging, although only one type of ranging is used at a time. Initial ranging 182 is performed by the wireless communication device at the time of network entry (e.g. when the wireless communication device enters the coverage area of the OFDMA system or when the wireless communication device is switched ON) to synchronize its uplink transmission with the base station. To perform initial ranging 182, the selected ranging code (which is one symbol time long) is transmitted twice in two consecutive symbols. The starting time of the ranging code does need not to be aligned with symbol timing. As a result, initial ranging 182 requires an additional symbol time to allow for timing error. In the example of prior art FIG. 1, a wireless communication device transmits a randomly selected code twice over two consecutive symbol times 131 to perform initial ranging 182 and the ranging slot 130 is called an initial ranging slot.

Handoff request ranging 184 is similar to initial ranging 182 and is performed by the wireless communication device to synchronize its uplink transmission with the base station when it enters into a new cell of the OFDMA system. Similar to initial ranging 182, the ranging code for handoff request ranging 184 (which is one symbol time long) is transmitted twice in two consecutive symbol times and does not need to be aligned with the symbol timing. Therefore, handoff request ranging 184 also requires an additional symbol time to allow for timing error similar to initial ranging 182. In the example of FIG. 1, a wireless communication device transmits a randomly selected ranging code twice over two consecutive symbol times 133 to perform handoff request ranging 184 and the ranging slot 130 is called a handoff request ranging slot.

Periodic ranging 186 is performed by the wireless communication device, periodically, to synchronize its uplink transmission with the base station. The ranging codes for the periodic ranging are aligned with the symbol timing. Therefore, it does not require any additional symbol time for timing error. In the example of prior art FIG. 1, the placement of symbols 134, 135, 136, 137 shows the ranging codes transmitted by the wireless communication devices for performing periodic ranging 186 and the ranging slot 130 is called a periodic ranging slot.

Bandwidth request ranging 188 is performed by the wireless communication device to request an allocation of bandwidth from the base station. The ranging codes for bandwidth request ranging also need to be aligned with the symbol timing. Similar to periodic ranging 186, bandwidth request ranging 188 also does not require any additional symbol time for timing error. In the example of prior art FIG. 1, symbols 138, 139 show the ranging codes transmitted by the wireless communication devices for performing bandwidth request ranging 188 and the ranging slot 130 is called a bandwidth request ranging slot.

Because the selection of a ranging slot and a ranging code is random, there is a very high probability of collision when two or more wireless communication devices attempt ranging. Although the ranging codes are semi-orthogonal with respect to each other to improve performance during collisions, the high probability of collision reduces the possibility of a successful ranging for a particular wireless communication device. It also reduces the number of wireless communication devices that can simultaneously perform ranging successfully. A possible solution for this problem is to designate more slots in the uplink sub-frame for ranging. However, this will reduce the data rate of the OFDMA system because additional slots for ranging will reduce the number of slots reserved for uplink data. Another possible solution is to increase the bandwidth of the channel so that more sub-channels can be allocated for ranging without reducing the data rate, but that is also not feasible because it would reduce the number of mobile stations that can be served by a single base station. Therefore, there is a need for a method for extending the ranging region without decreasing the data rate and without requiring more bandwidth.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows a three stage blow-up of a prior art OFDMA frame.

FIG. 2 shows an OFDMA frame with an extended ranging region at a wireless communication device in accordance with some embodiments of the present invention.

FIG. 3 shows an OFDMA frame with an extended ranging region at a base station in accordance with some embodiments of the present invention.

FIG. 4 is a flow chart illustrating a method for a wireless communication device to extend a ranging region in accordance with some embodiments of the present invention.

FIG. 5 is a flow chart illustrating a method for a base station to extend a ranging region in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The OFDMA frame and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a method for uplink synchronization, in a wireless communication device, with a base station in a wireless communication system based on Orthogonal Frequency Division Multiple Access (OFDMA). The wireless communication device selects a ranging slot randomly from ranging slots either completely or partially in a transition gap and transmits a ranging code in the selected ranging slot. According to the present invention, the ranging region is extended by utilizing symbols in a transition gap of an OFDMA frame. The transition gap can be a TTG or an RTG, depending upon the location of the ranging region in the OFDMA frame. Note that because the extra transmission in the transmissions gap is a transmission earlier in time than other devices not utilizing this invention, and because devices in other cells are geographically more distant corresponding to a longer propagation delay, other devices will not interfere with the present invention.

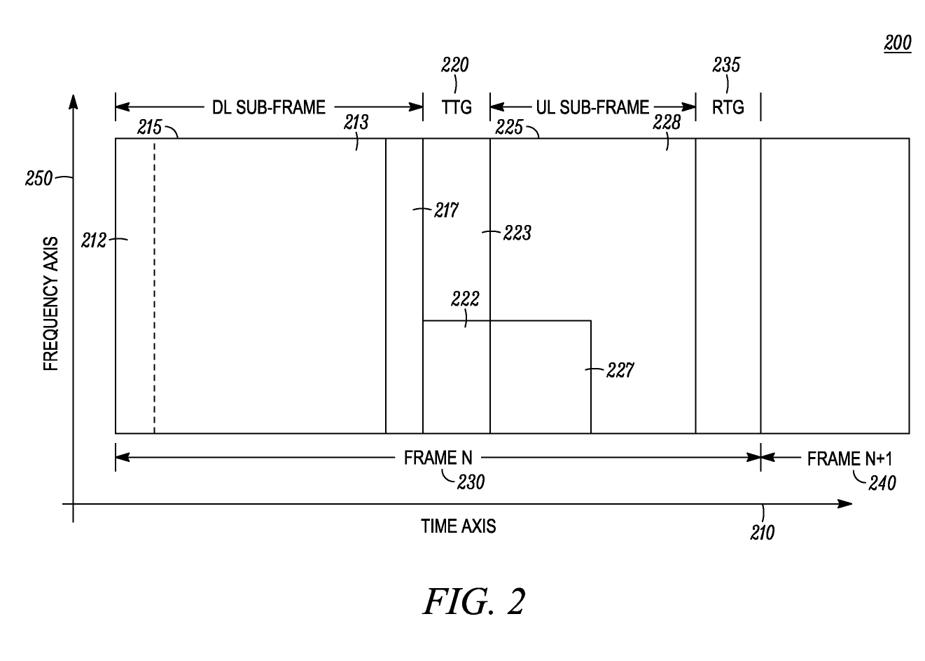

FIG. 2 shows an OFDMA frame 200 with an extended ranging region at a wireless communication device in accordance with some embodiments of the present invention. FIG. 2 illustrates an OFDMA frame N 230 and a portion of a downlink sub-frame of a subsequent frame N+1 240. Each OFDMA frame is spread along a time axis 210 and a frequency axis 250. The time axis 210 includes multiple symbol times and the frequency axis 250 includes different sub-channels.

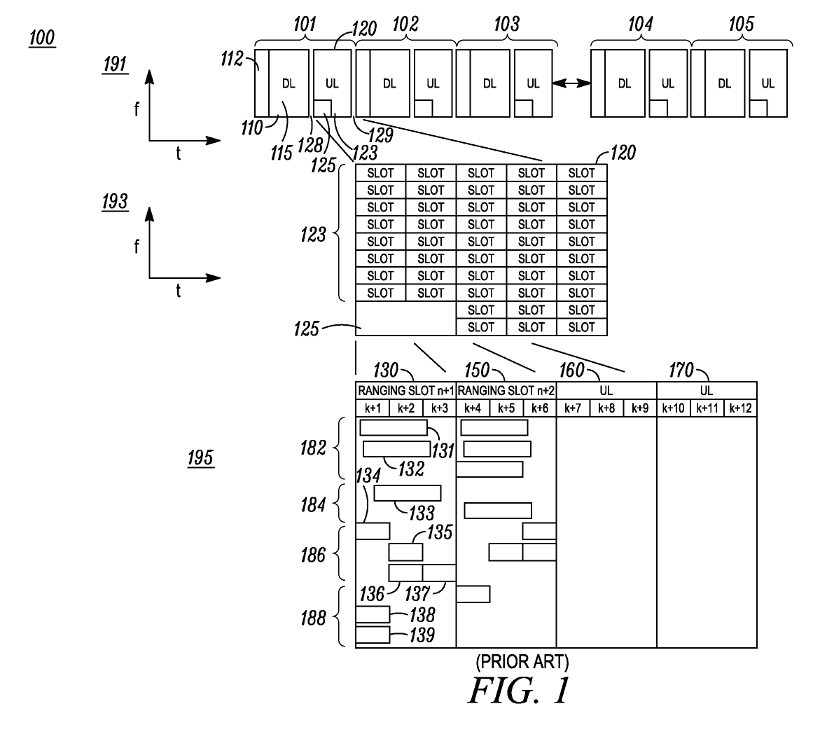

The OFDMA frame N 230 has a downlink sub-frame 215, a TTG 220, an uplink sub-frame 225 and an RTG 235. The downlink sub-frame 215 is divided into two portions 212, 213. The leading portion 212 of the downlink sub-frame 215 has a preamble, an FCH, a DL-MAP, a UL-MAP, a DCD, and a UCD as explained earlier in conjunction with prior art FIG. 1. The following portion 213 is divided into a plurality of slots. The base station uses the slots in the following portion 213 to transmit data bursts to the wireless communication device. In other words, the wireless communication device receives data bursts during the slots in the latter portion 213 of the downlink sub-frame 215. The wireless communication device receives parameters in the downlink sub-frame 215 that inform the wireless communication device that it is permitted to use a transition gap for ranging. In one example, the UCD contains parameters that inform the wireless communication device that it is permitted to use a TTG for ranging. In another example, the DCD contains parameters that inform the wireless communication device that it is permitted to use the TTG for ranging. In a third example, a base station's response to a registration request (REG-RSP) contains parameters that inform the wireless communication device that it is permitted to use a TTG for ranging. In another example, the wireless communication device may be pre-programmed to use the TTG for ranging.

The TTG is conventionally used by the wireless communication device to switch its transceiver from a receive mode to a transmit mode. If the wireless communication device uses the TTG to perform ranging, then the wireless communication device uses the tail end 217 of the downlink sub-frame 215 to switch its transceiver from a receive mode to a transmit mode and thus does not receive data bursts transmitted by the base station during the tail end 217. Depending upon the distance between the base station and the wireless communication device, the wireless communication device may only decide to range in the transition gap if it does not have a data allocation in the last symbol of the downlink sub-frame 215. If the wireless communication device is close enough to the base station, it may be possible to utilize the transition gap for ranging even if it has an allocation including the last symbol of the downlink sub-frame 215 due to a very short actual round trip propagation delay time. Therefore, the wireless communication device can switch its transceiver from the receive mode to the transmit mode in the tail end 217 of the downlink sub-frame without losing any amount of data.

The uplink sub-frame 225 is divided into two portions 227, 228, similar to the uplink sub-frame 120 of prior art FIG. 1. The uplink data portion 228 has a plurality of slots, which are allocated to different wireless communication devices for transmitting their data bursts. The ranging portion 227 is the conventional ranging region allocated in the uplink sub-frame 225 (similar to the ranging region 125 of the uplink sub-frame 120 of prior art FIG. 1) by the base station to the wireless communication devices to perform ranging by transmitting ranging codes. The uplink sub-frame 225 is separated from the downlink sub-frame 215 by TTG 220. Similarly, the uplink sub-frame 225 of the frame N 230 is separated from the downlink sub-frame of the subsequent frame N+1 240 by the RTG 235.

In one example, the TTG 220 is at least one symbol time long and the conventional ranging region 227 is present at the beginning of the uplink sub-frame 225. Now, the extended ranging region includes conventional ranging region 227 of the uplink sub-frame and an extended ranging portion 222 of the TTG 220. For performing initial ranging, the wireless communication device requires at least two consecutive symbols for repetitively transmitting an initial ranging code twice to the base station. The wireless communication device may use one symbol time in the extended ranging portion 222 of the TTG 220 and the second consecutive symbol time in the conventional ranging region 227 of the uplink sub-frame 225 for initial ranging. The additional symbol time required to accommodate any timing error, as explained earlier, can be from the conventional ranging region 227 of the uplink sub-frame. Thus, the wireless communication device may randomly select two consecutive symbols from the extended ranging region, which includes both the extended ranging portion 222 and the conventional ranging region 227 of the uplink sub-frame 225.

In another example, the TTG 220 is at least three symbol times long and the wireless communication device may use three symbols in the extended ranging portion 222 of the TTG 220 for initial ranging. In this example, merely TTG 220 may be used for initial ranging, as it includes at least three symbol times required for initial ranging (two symbol times for transmitting code and one symbol time to accommodate any timing error). In this case, the uplink sub-frame 225 may omit the conventional ranging region 227 in the uplink sub-frame 225. In the case where the uplink sub-frame 225 does not contain the conventional ranging region 227, the extended ranging region may be equal to the extended ranging portion 222 of the TTG 220. In another example, the extended ranging region includes all the sub-channels of the TTG 220, if the uplink sub-frame 225 does not contain the conventional ranging region 227.

Alternatively, if the uplink sub-frame 225 contains the conventional ranging region 227, the extended ranging region may be equal to the extended ranging portion 222 of the TTG 220 and the conventional ranging region 227 in the uplink sub-frame 225.

The technique described above of using the TTG 220 for initial ranging may be extended to all other types of ranging. For example, in handoff request ranging, the wireless communication device transmits a handoff request ranging code in the same way as it transmits the initial ranging codes for initial ranging. However, in the examples of periodic ranging and bandwidth request ranging, the wireless communication device requires only one symbol time to transmit one ranging code. As a result, the wireless communication device may use a ranging slot of at least one symbol time long in a TTG 223 for performing ranging. Similarly, the RTG 235 may also be used for all types of ranging, if the RTG 235 is at least one symbol time long and the conventional ranging region 227 is present at the tail end of the uplink sub-frame 225.

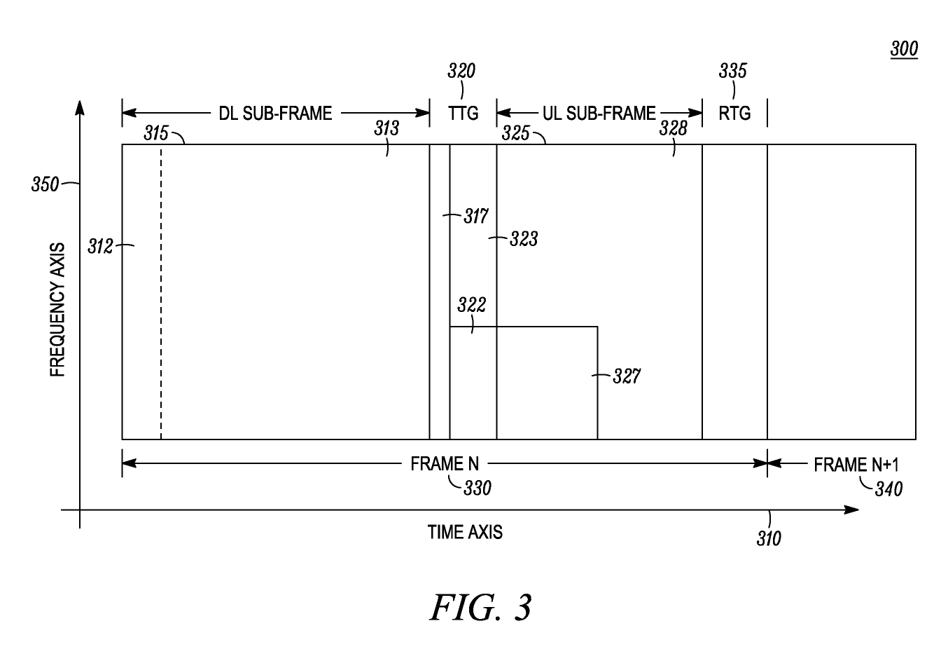

FIG. 3 shows an OFDMA frame 300 with an extended ranging region at a base station in accordance with some embodiments of the present invention. FIG. 3 shows an OFDMA frame N 330 and a portion of a downlink sub-frame of a subsequent frame N+1 340. Each OFDMA frame is spread along a time axis 310 and a frequency axis 350. The time axis 310 includes symbol times and the frequency axis 350 includes sub-channels. The OFDMA frames shown in FIG. 3 are same as the OFDMA frames shown in FIG. 2, but are explained from a base station's prospective.

The OFDMA frame N 330 has a downlink sub-frame 315, a TTG 320, an uplink sub-frame 325, and an RTG 335. The downlink sub-frame 315 is divided into two portions 312, 313. In the leading portion 312 of the downlink sub-frame 315, the base station broadcasts a preamble, an FCH, a DL-MAP, a UL-MAP, a DCD, and a UCD. In the latter portion 313 of the downlink sub-frame 315, the base station transmits data bursts for different wireless communication devices. The base station transmits parameters in the downlink sub-frame 315 to inform the wireless communication device that it is permitted to use a transition gap for ranging. In one example, the UCD contains parameters that inform the wireless communication device that it is permitted to use a TTG for ranging. In another example, the DCD contains parameters that inform the wireless communication device that it is permitted to use the TTG for ranging. In a third example, a base station's response to a registration request (REG-RSP) contains parameters that inform the wireless communication device that it is permitted to use a TTG for ranging. In another example, the wireless communication device is pre-programmed to use the TTG for ranging.

The uplink sub-frame 325 is divided into two portions 327, 328. In the uplink data portion 328, the base station receives data bursts transmitted by different wireless communication devices. The ranging portion 327 is the conventional ranging region allocated in the uplink sub-frame 325, in which the base station conventionally looks for ranging codes transmitted by the wireless communication devices.

The TTG 320 separates the downlink sub-frame 315 and the uplink sub-frame 325. The TTG 320 has three portions 317, 322, 323. In the first portion 317, the base station switches its transceiver from a transmit mode to a receive mode. The extended ranging portion 322 has the same sub-channels that are allocated for ranging in the conventional ranging region 327.

Similar to the alternatives discussed with reference to FIG. 2, in one example of FIG. 3, the extended ranging region may include the extended ranging portion 322 of the TTG 320 and the conventional ranging region 327 of the uplink sub-frame 325. In another example, the extended ranging region may be only the extended ranging portion 322 of the TTG 320. In yet another example, the extended ranging region may include the extended ranging portion 322 and the extended sub-channel ranging portion 323 of the TTG 320. As explained with reference to FIG. 2, RTG 335 may also be used for ranging.

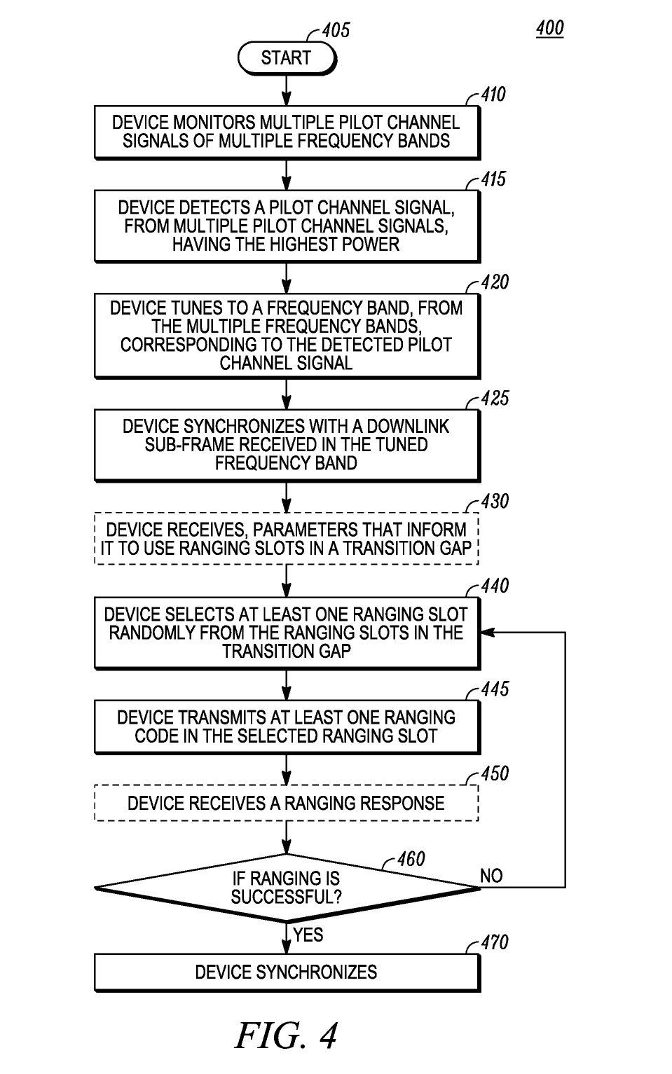

FIG. 4 is a flow chart 400 illustrating a method for a wireless communication device to extend a ranging region in accordance with some embodiments of the present invention. The method 400 starts in step 405, when a wireless communication device is switched ON in a coverage area of an OFDMA system. (In another example, in step 405, the wireless communication device may enter a coverage area of an OFDMA system.) Now, the first kind of ranging the wireless communication device needs to perform is initial ranging.

Initially, when the wireless communication device is switched ON, it monitors multiple pilot channel signals of multiple frequency bands in step 410. In one example, a user of the wireless communication device may select the set of the multiple frequency bands. In another example, the set of the multiple frequency bands is pre-stored in the memory of the wireless communication device.

As a result of monitoring, the wireless communication device detects a pilot channel signal, from the multiple pilot channel signals, having the highest power in step 415. Now, the wireless communication device tunes to a frequency band, from the multiple frequency bands, corresponding to the detected pilot channel signal in step 420. The steps 410, 415, 420 explained above describe one method of tuning a wireless communication device to a frequency band. Any other method known in the art may be substituted for the method explained above for tuning the wireless communication device to a frequency band.

Once tuned to a frequency band, the wireless communication device starts monitoring the tuned frequency band. As a result of monitoring, the wireless communication device receives a preamble of a downlink sub-frame in the tuned frequency band. The wireless communication device synchronizes with a downlink sub-frame received in the tuned frequency band in step 425.

After downlink synchronization, the wireless communication device may receive parameters in a downlink sub-frame that informs the wireless communication device that it is permitted to use initial ranging slots in a transition gap in step 430. In one example, a UCD in the downlink sub-frame contains parameters that inform the wireless communication device to use initial ranging slots in a TTG. In another example, a DCD in the downlink sub-frame contains parameters that inform the wireless communication device to use the TTG for initial ranging slots in the TTG. In a third example, a base station's response to a registration request (REG-RSP) contains parameters that inform the wireless communication device that it is permitted to use a TTG for ranging. Alternatively, the wireless communication device is pre-programmed to use the initial ranging slots in the TTG and thus does not receive any parameters that inform it to use ranging slots in a transition gap.

After the wireless communication device knows that it can use ranging slots in the transition gap, the wireless communication device randomly selects at least one ranging slot from the ranging slots in the transition gap in step 440. After selecting the at least one ranging slot, the wireless communication device randomly selects a ranging code from a set of ranging codes allocated for initial ranging and transmits the randomly selected ranging code in the randomly selected ranging slot in step 445.

In the example of FIG. 4, the wireless communication device is performing initial ranging. To perform initial ranging, the wireless communication device has to repetitively transmit an initial ranging code twice in two consecutive symbol times. We shall use, as an example, the OFDMA frames of FIG. 2. In one example, the TTG 220 is at least one symbol time long and the conventional ranging region 227 is present at the beginning of the uplink sub-frame 225. In this case, the wireless communication device may select at least one ranging slot of at least one symbol time from the ranging slots in the transition gap in step 440 and transmit a randomly selected initial ranging code in the selected ranging slot in step 445. The wireless communication device then also selects 440 the second consecutive symbol time in the conventional ranging region 227 of the uplink sub-frame 225 and transmits the randomly selected initial ranging code again in the selected ranging slot in step 445. Because the starting time of the ranging code may not be aligned with symbol timing, the conventional ranging region 227 of the uplink sub-frame 225 provides an additional symbol time used to accommodate possible timing error. In another example, the TTG 220 is at least three symbol times long and the conventional ranging region 227 may or may not be present at the beginning of the uplink sub-frame 225. In this case, the wireless communication device may select both the symbol times in the extended ranging portion 222 of the TTG 220 in step 440, and the extended ranging portion 222 of the TTG 220 provides an additional symbol time required for timing error. Similarly, the RTG 235 may also be used for transmitting the initial ranging codes, if the conventional ranging region 227 is present at the tail end of the uplink sub-frame 225.

In response to the transmitted ranging codes, the wireless communication device may receive a ranging response from the base station in step 450. The ranging response includes a status message that indicates to the wireless communication device whether the ranging request was successful or not. The ranging response message also includes adjustment information required by the wireless communication device. This adjustment information includes a timing offset, a frequency offset, and a transmission power for uplink synchronization of the wireless communication device. The ranging response message is broadcasted by the base station. The wireless communication device recognizes the ranging response message by the symbol number of the ranging slot and the ranging code contained in the ranging response message, which are same as the symbol number of the ranging slot and the ranging code used by the wireless communication device for ranging.

After receiving the ranging response message, the wireless communication device checks the status of the ranging response message broadcasted by the base station. If status message indicates that the initial ranging code is received successfully 460 by the base station, the wireless communication device synchronizes its uplink sub-frame with the base station in step 470 (i.e., the wireless communication device adjusts the timing offset, the frequency offset, and the transmission power of the uplink transmission according to the ranging response message).

If the wireless communication device does not receive a ranging response message in step 450 or if the status of the ranging response message indicates that the initial ranging code was not received successfully 460, the wireless communication device waits for a random interval of time and goes back to step 440. The wireless communication device keeps on repeating the process of initial ranging until the status of the ranging response message indicates that the initial ranging code is successfully received by the base station.

When the wireless communication device moves from one cell to another cell in the coverage area of the OFDMA system, the wireless communication device performs handoff request ranging. In handoff request ranging, the wireless communication device repetitively transmits a handoff request ranging code twice in two consecutive symbol times. The transition gap may be used by the wireless communication device to perform handoff request ranging in the same manner as described above for initial ranging. When the wireless communication device performs periodic ranging or bandwidth request ranging, only one symbol time is used for transmitting a periodic ranging code or a bandwidth request ranging code. In this case, the wireless communication device may use a symbol time in the transition gap, if the transition gap is at least one symbol time long, in accordance with the flow chart 400 of FIG. 4.

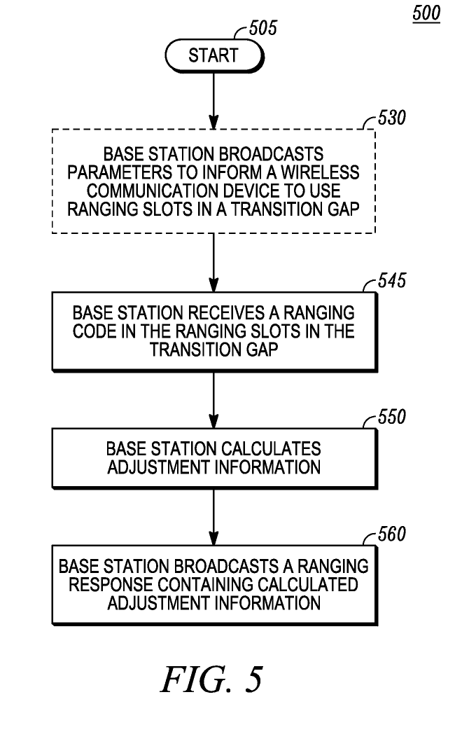

FIG. 5 is a flow chart 500 illustrating a method for a base station to extend a ranging region in accordance with some embodiments of the present invention. The method of FIG. 5 starts in step 505, when the base station is downlink synchronized with the wireless communication device. In optional step 530, the base station broadcasts parameters in a downlink sub-frame that inform a wireless communication device that it is permitted to use ranging slots in a transition gap for ranging. In one example, the UCD contains parameters that inform the wireless communication device to use ranging slots in a transition gap for ranging. In another example, the DCD contains parameters that inform the wireless communication device to use ranging slots in a transition gap for ranging. If step 530 is not performed, the base station does not broadcast the said parameters in the downlink sub-frame. Instead, the wireless communication device is pre-programmed to use slots in a transition gap for ranging. In any case, the base station should know that the wireless communication device may transmit ranging codes in the slots in a transition gap.

In step 545, the base station receives a ranging code in a ranging slot in a transition gap. After receiving the ranging code, the base station calculates adjustment information required by the wireless communication device by estimating time taken by a signal to reach the base station in step 550 from the wireless communication device.

After calculating the adjustment information, the base station broadcasts a ranging response message containing the adjustment information calculated by the base station in step 560. The ranging response message also contains a status that informs the wireless communication device whether the ranging is successful or not. The ranging response message also contains a ranging code received by the base station and a symbol number of the ranging slot in which it was received. The wireless communication device uses the ranging code and the symbol number of the ranging slot to identify that the ranging response message belongs to the wireless communication device.

The method of extending a ranging region in an OFDMA system by using transition gaps for ranging helps a higher number of wireless communication devices to simultaneously perform ranging successfully without requiring more bandwidth and without reducing the overall data rate of the OFDMA system. The possibility of a collision, which may occur when two or more wireless communication devices transmit the same ranging code in the same ranging slot, is reduced. Moreover, extending the ranging region also helps to increase the cell radius. The ranging code transmitted by the wireless communication device takes some time to reach the base station due to propagation delay. Therefore, a ranging code transmitted, by a wireless communication device that is extremely far away from the base station, during a TTG may reach the base station in the conventional ranging region of the uplink sub-frame. Accordingly, there is an increase in the maximum distance from the base station at which the wireless communication device can perform ranging by using transition gap for ranging.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for uplink synchronization, in a wireless communication device, with a base station in a wireless communication system based on Orthogonal Frequency Division Multiple Access (OFDMA), comprising:
selecting, by the wireless communication device, at least one ranging slot randomly from ranging slots in at least a transition gap; and
transmitting, by the wireless communication device, at least one ranging code in the selected at least one ranging slot.

2. The method of claim 1, wherein the at least one ranging slot is at least one symbol time long.

3. The method of claim 2, wherein the at least one ranging slot is an initial ranging slot.

4. The method of claim 2, wherein the at least one ranging slot is a handoff request ranging slot.

5. The method of claim 2, wherein the at least one ranging slot is a periodic ranging slot.

6. The method of claim 2, wherein the at least one ranging slot is a bandwidth request ranging slot.

7. The method of claim 1, wherein the selected at least one ranging slot is entirely in the transition gap.

8. The method of claim 1, further comprising:
monitoring, by the wireless communication device, multiple pilot channel signals of multiple frequency bands;
detecting, by the wireless communication device, a pilot channel signal, from the multiple pilot channel signals, having a highest power;
tuning, by the wireless communication device, to a frequency band, from the multiple frequency bands, corresponding to the pilot channel signal; and
synchronizing, by the wireless communication device, with a downlink sub-frame received in the frequency band, before the selecting.

9. The method of claim 8 further comprising:
receiving, by the wireless communication device, parameters that inform the wireless communication device that ranging slots are in at least the transition gap.

10. The method of claim 9 further comprising:
receiving, by the wireless communication device, in a downlink sub-frame, parameters that inform the wireless communication device that the wireless communication device is permitted to use the ranging slots in the transition gap.

11. The method of claim 1, wherein the wireless communication device is pre-programmed to use ranging slots in the transition gap.

12. The method of claim 1, wherein the ranging slots are also in an uplink sub-frame.

13. The method of claim 12, wherein the ranging slots in the uplink sub-frame are at a beginning of the uplink sub-frame.

14. The method of claim 13, wherein the transition gap is a transmit/receive transition gap.

15. The method of claim 12, wherein the ranging slots in the uplink sub-frame are at tail end of the uplink sub-frame.

16. The method of claim 15, wherein the transition gap is a receive/transmit transition gap.

17. The method of claim 1, wherein the at least one ranging code is an initial ranging code, randomly chosen from a plurality of codes used for initial ranging.

18. The method of claim 1, wherein the transition gap is at least one symbol time long.

19. The method of claim 1, further comprising:
receiving, by the wireless communication device, a ranging response message from the base station, after transmitting.

20. The method of claim 19, wherein the ranging response message is an initial ranging response message.

21. A method for uplink synchronization between a base station and a wireless communication device in a wireless communication system based on Orthogonal Frequency Division Multiple Access (OFDMA), comprising:
receiving, by the base station, at least one ranging code in a ranging slot, wherein the ranging slot is at least partially located in a transition gap.

22. The method of claim 21 further comprising:
broadcasting, by the base station, parameters to inform the wireless communication device that the wireless communication device is permitted to use the ranging slot in the transition gap, before the receiving.

23. The method of claim 21 further comprising:
broadcasting, by the base station, in a downlink sub-frame, parameters to inform the wireless communication device that the wireless communication device is permitted to use the ranging slot in the transition gap, before the receiving.

24. The method of claim 21, wherein the ranging slot is an initial ranging slot and the at least one ranging code is an initial ranging code.

25. The method of claim 21, further comprising, after the receiving:
calculating, by the base station, adjustment information, wherein the adjustment information includes at least a frequency adjustment, a timing adjustment, or a power adjustment; and
broadcasting, by the base station, an initial ranging response, wherein the initial ranging response contains the adjustment information.
